(19) United States
(12) Patent Application Publication
(10) Pub. No.: US 2013/0293956 A1
(43) Pub. Date: Nov. 7, 2013

(54) OPTICAL SYSTEM FOR IMAGE OF AN OBJECT

(71) Applicant: Carl Zeiss Sports Optics GmbH, Wetzlar (DE)

(72) Inventors: Dirk Dobermann, Magdala OT Ottstedt (DE); Karsten Kuhn, Oberweissbach (DE)

(21) Appl. No.: 13/863,454

(22) Filed: Apr. 16, 2013

Related U.S. Application Data
(60) Provisional application No. 61/624,642, filed on Apr. 16, 2012.

(30) Foreign Application Priority Data
Apr. 16, 2012 (DE) 102012206230.0

(51) Int. Cl. G02B 27/64

(52) U.S. Cl. CPC G02B 27/64
USPC 359/480; 359/554

(57) ABSTRACT

An optical system for imaging an object is provided that is in particular embodied as binocular field glasses, as monocular field glasses, as a spotting scope or as a telescope. The optical system comprises at least one first objective, at least one first image stabilizing unit, and at least one first eyepiece. As seen from the first objective in the direction of the first eyepiece, the first objective is arranged first along a first optical axis in a first housing, followed by the first image stabilizing unit and then the first eyepiece. The first image stabilizing unit is mounted in a cardan-joint fashion in the first housing, rotatably about a first hinge point, wherein the first hinge point is arranged between the first objective and the first eyepiece. Furthermore, the optical system comprises at least one first drive unit for contactless driving of the first image stabilizing unit.

The invention relates to an optical system for imaging an object, wherein the optical system comprises at least one objective, at least one image stabilizing unit and at least one eyepiece. In particular, the optical system is embodied as binocular field glasses, as monocular field glasses, as a spotting scope or as a telescope.

The optical system referred to above is used, for example, in a telescope or in field glasses. The image captured by a user through the telescope or through the field glasses is often perceived to be blurry, since trembling movements or rotation movements of the hands of the user, but also movements of the ground below, in turn cause movements of the optical system. In order to avoid this, it is known practice to stabilize images in an optical system. Known solutions use stabilizing apparatuses for stabilizing the image by means of a mechanical apparatus and/or an electronic apparatus. Furthermore, so-called passive stabilizations and active stabilizations are known, as will still be explained in more detail below.

A passive stabilization is known from DE 23 53 101 C3. This document describes an optical system in the form of a telescope, which comprises an objective, an image stabilizing unit in the form of a prism erecting system and an eyepiece. As seen from the objective in the direction of the eyepiece, the objective is arranged first along an optical axis of the optical system, followed by the image stabilizing unit and then the eyepiece. The prism erecting system is mounted in a cardan-joint fashion in a housing of the telescope. This is understood to mean that the prism erecting system is arranged in the housing of the telescope in such a way that the prism erecting system is rotatably mounted about two axes which are arranged at right angles to one another. For the purposes of rotational mounting, a device is used which is referred to as a cardan suspension. The two aforementioned axes intersect at a hinge point. In the known optical system, provision is now made for the hinge point to be arranged centrally between an image-side main plane of the objective and an object-side main plane of the eyepiece. The mounted in a cardan-joint fashion prism erecting system is not moved by occurring rotational tremor movements as a result of its inertia (passive stabilization). It therefore remains stationary in space. This is how image blurring, which is created as a result of the rotational tremor movement of the housing, is compensated for.

By way of example, DE 39 33 255 C2 discloses an active stabilization. This document discloses binocular field glasses with an image stabilization, which comprises a prism erecting system. The prism erecting system comprises Porro prisms, which respectively have a tilt axis. The Porro prisms are embodied so as to be able to pivot about their respective tilt axis. Motors are provided for pivoting the Porro prisms (active stabilization). The pivoting occurs depending on a trembling movement which causes blurring of an observed image, and so an image deterioration is avoided.

A further example of a known passive stabilization is disclosed in DE 28 34 158 C3. This document discloses a telescope with an arrangement consisting of an objective, a prism erecting system and an eyepiece, wherein provision is made for two partial telescopes, which respectively have a copy of the aforementioned arrangement. The prisms of the prism erecting systems of both partial telescopes are mounted on a common cardan suspension in a housing. The hinge point lies in the center between the image-side main plane of the objective and the object-side main plane of the eyepiece. Moreover, the hinge point lies at the center of gravity of the cardan suspension. It was found that each of the prism erecting systems should be arranged closer to the corresponding eyepiece than to the corresponding objective in the case of telescopes with a magnification of e.g. greater than 4. So that each prism erecting system in the cardan suspension is in equilibrium, it is necessary to provide at least one balancing weight.

Deliberations have now shown that an almost complete stabilization of the image position is not achieved in the case of a passive stabilization. Although a relatively high degree of stabilization in the image position is achieved for movements, which have frequencies of greater than approximately 10 Hz, in the known optical systems, complete stabilization of the image position is nevertheless generally not obtained with the known passive stabilizations. For movements with frequencies of less than approximately 10 Hz, only a low degree of stabilization of the image position is generally achieved with the known passive stabilizations, which are based on inertia (see above).

The invention is therefore based on the object of specifying an optical system with image stabilization, by means of which it is possible to achieve the best possible stabilization of the image position for each frequency range of a movement of the optical system.

According to the invention, this object is achieved by an optical system with the features of Claim 1. Further features of the invention emerge from the following description, the following claims and/or the attached figures.

According to the invention, the optical system comprises at least one first objective, at least one first image stabilizing unit and at least one first eyepiece. As seen from the first objective in the direction of the first eyepiece, the first objective is arranged first along a first optical axis in a first housing, followed by the first image stabilizing unit and then the first eyepiece. The first image stabilizing unit is mounted in a cardan-joint fashion in the first housing, rotatably about a first hinge point. Here, a cardan-type mount of the first image stabilizing unit is understood to mean that the first image stabilizing unit is arranged in such a way that the first image stabilizing unit is mounted rotatably about two axes arranged at an angle with respect to one another, namely about a first axis and about a second axis. By way of example, the first axis and the second axis are arranged perpendicular to one another. Other exemplary embodiments provide for the first axis and the second axis to be arranged at an angle in the range from 60° to 85° with respect to one another. The point of intersection between the first axis and the second axis (and also optionally the first optical axis) is the first hinge point. Furthermore, the first hinge point is arranged between the first objective and the first eyepiece. In the optical system, provision is furthermore made for at least one first drive unit for contactless driving of the first image stabilizing unit. Here, both above and below, a contactless drive is understood to mean a drive in which an adjustment force acts on the first image stabilizing unit without the first image stabilizing unit coming into contact with a component which could exert a force on the first image stabilizing unit by contacting the first image stabilizing unit. By way of example, the adjustment force is provided by an electromagnetic drive and/or a capacitive drive.

The invention is an active stabilization, which is made possible by the at least one first drive unit. However, the invention also contains a passive stabilization as a result of the cardan-type mount of the first image stabilizing unit in the optical system. The invention is based on the deliberations that the inertia of the first image stabilizing unit already makes a contribution to stabilizing the image position. However, as already mentioned above, the degree of stabilization of the image position does not reach 100%, but rather it is desirable for there to be a stabilization of the remainder in order to achieve a degree of stabilization of almost 100% or precisely 100%. In the invention, this remainder is stabilized by means of the active stabilization, with at least the first drive unit being used. Deliberations have shown that the stabilization of the remainder can occur particularly well by means of a contactless drive of the first image stabilizing unit. In particular, it is advantageous that such drive units can be actuated well.

In one embodiment of the optical system according to the invention, provision is additionally or alternatively made for the optical system to comprise at least one second drive unit for contactless driving of the first image stabilizing unit and/or at least one third drive unit for contactless driving of the first image stabilizing unit and/or at least one fourth drive unit for contactless driving of the first image stabilizing unit. In one exemplary embodiment of the optical system according to the invention, provision is made for at least three of the aforementioned drive units to be provided in the optical system. Deliberations have shown that the use of at least three of the aforementioned drive units ensures particularly good tilting of the first image stabilizing unit about the first axis and/or about the second axis. However, the invention is not restricted to this number of drive units. Rather, any suitable number of drive units can be used in the invention. By way of example, four drive units or eight drive units are provided in further exemplary embodiments.

In an in turn further exemplary embodiment of the optical system according to the invention, provision is additionally or alternatively made for the first drive unit to be embodied as an electromagnetic actuator or as a capacitive actuator. Furthermore, provision is additionally or alternatively made for the optical system to comprise at least one of the following features:
the second drive unit is embodied as an electromagnetic actuator or as a capacitive actuator,
the third drive unit is embodied as an electromagnetic actuator or as a capacitive actuator, or
the fourth drive unit is embodied as an electromagnetic actuator or as a capacitive actuator.

In an in turn further exemplary embodiment of the optical system according to the invention, provision is additionally or alternatively made for at least one of the drive units from the set containing the first drive unit, the second drive unit, the third drive unit and the fourth drive unit to comprise at least one first drive element and at least one second drive element. By way of example, the first drive element is arranged at the first housing. As an alternative to this, provision is made for the first drive unit to be arranged at the cardan suspension. Moreover, provision is made for the second drive element to be arranged at the first image stabilizing unit. By way of example, if at least one of the aforementioned drive units is embodied as an electromagnetic actuator, then the first drive element and the second drive element are, for example, embodied as coil and armature element, respectively. Alternatively, provision is made for the first drive element to be embodied as an armature element and for the second drive element to be embodied as a coil. In a further embodiment form, provision is made, for example, for at least one of the aforementioned drive units to be embodied as a capacitive actuator. By way of example, in this case the first drive element is embodied as a first electrode and the second drive element is embodied as a second electrode, wherein the first electrode and the second electrode form a first capacitor.

In one exemplary embodiment of the optical system according to the invention, provision is additionally or alternatively made for the first image stabilizing unit to have a tubular design. This embodiment is also referred to as first stabilizing tube. In particular, provision is furthermore made for the first image stabilizing unit, at its center of gravity, to be arranged at a first cardan joint (cardan suspension), wherein the first cardan joint is arranged at the first housing. Hence, the first image stabilizing unit is not arranged directly on the first housing, but only arranged at the first housing via the first cardan joint.

In a further exemplary embodiment of the optical system according to the invention, provision is additionally or alternatively made for the first image stabilizing unit to have at least one first erecting system in the form of a first prism erecting system or a first lens erecting system. In an in turn further exemplary embodiment of the optical system according to the invention, provision is additionally or alternatively made for the first image stabilizing unit to have at least one first mass-balancing element, wherein the first mass-balancing element is, for example, adjustably mounted along the first optical axis and/or perpendicular to the first optical axis. In this respect, provision is additionally or alternatively made for the first image stabilizing unit to have at least one second mass-balancing element, wherein the second mass-balancing element is, for example, adjustably mounted along the first optical axis and/or perpendicular to the first optical axis. The first mass-balancing element and/or the second mass-balancing element are used to set the center of gravity of the first image stabilizing unit in the first hinge point.

In one embodiment of the optical system according to the invention, provision is additionally or alternatively made for at least one first sensor unit for establishing a movement of the optical system to be arranged at the first housing. As an alternative to this, provision is made for the first sensor unit to be arranged at the first cardan joint. By way of example, the first sensor unit is embodied as a rate sensor or accelerometer. However, the invention is not restricted to the aforementioned sensors. Rather any suitable sensor can be used as first sensor unit.

In a further embodiment of the optical system according to the invention, provision is additionally or alternatively made for the optical system to comprise at least one second objective, at least one second image stabilizing unit and at least one second eyepiece. As seen from the second objective in the direction of the second eyepiece, the second objective is arranged first along a second optical axis in a second housing, followed by the second image stabilizing unit and then the second eyepiece. The second image stabilizing unit is mounted in a cardan-joint fashion in the second housing, rotatably about a second hinge point. Accordingly, the second image stabilizing unit is mounted rotatably about two axes arranged at an angle with respect to one another, namely about a third axis and about a fourth axis. By way of example, the third axis and the fourth axis are arranged perpendicular to one another. Other exemplary embodiments provide for the third axis and the fourth axis to be arranged at an angle in the range from 60° to 85° with respect to one another. The point of intersection between the third axis and the fourth axis (and also optionally the second optical axis) is the second hinge point. Furthermore, the second hinge point is arranged between the second objective and the second eyepiece. In the optical system, provision is furthermore made for at least one fifth drive unit for contactless driving of the second image stabilizing unit. In respect of the contactless drive, the statements already made above apply accordingly.

In one embodiment of the optical system according to the invention, provision is additionally or alternatively made for the optical system to comprise at least one sixth drive unit for contactless driving of the second image stabilizing unit and/or at least one seventh drive unit for contactless driving of the second image stabilizing unit and/or at least one eighth drive unit for contactless driving of the second image stabilizing unit. In one exemplary embodiment of the optical system according to the invention, provision is also made for at least three of the aforementioned drive units to be provided in the optical system. The use of at least three of the aforementioned drive units is advantageous for ensuring particularly good tilting of the second image stabilizing unit about the third axis and/or about the fourth axis. However, the invention is not restricted to this number of drive units. Rather, any suitable number of drive units can be used in the invention. By way of example, four drive units or eight drive units are provided in further exemplary embodiments.

In an in turn further exemplary embodiment of the optical system according to the invention, provision is additionally or alternatively made for the fifth drive unit to be embodied as an electromagnetic actuator or as a capacitive actuator. Furthermore, provision is additionally or alternatively made for the optical system to comprise at least one of the following features:
the sixth drive unit is embodied as an electromagnetic actuator or as a capacitive actuator,
the seventh drive unit is embodied as an electromagnetic actuator or as a capacitive actuator, or
the eighth drive unit is embodied as an electromagnetic actuator or as a capacitive actuator.

In an in turn further exemplary embodiment of the optical system according to the invention, provision is additionally or alternatively made for at least one of the drive units from the set containing the fifth drive unit, the sixth drive unit, the seventh drive unit and the eighth drive unit to comprise at least one third drive element and at least one fourth drive element. By way of example, the third drive element is arranged at the second housing. As an alternative to this, provision is made for the third drive element to be arranged at the second cardan joint (cardan suspension). Moreover, provision is made for the fourth drive element to be arranged at the second image stabilizing unit. By way of example, if at least one of the drive units is embodied as an electromagnetic actuator, then the third drive element is, for example, embodied as a coil and the fourth drive element is embodied as an armature element. Alternatively, provision is made for the third drive element to be embodied as an armature element and for the fourth drive element to be embodied as a coil. In a further embodiment, provision is made, for example, for at least one of the drive units to be embodied as a capacitive actuator. By way of example, in this case the third drive element is embodied as a third electrode and the fourth drive element is embodied as a fourth electrode, wherein the third electrode and the fourth electrode form a second capacitor.

In one exemplary embodiment of the optical system according to the invention, provision is additionally or alternatively made for the second image stabilizing unit to have a tubular design. This embodiment is also referred to as second stabilizing tube. In particular, provision is furthermore made for the second image stabilizing unit, at its center of gravity, to be arranged at the second cardan joint (cardan suspension), wherein the second cardan joint is arranged at the second housing. Hence, the second image stabilizing unit is not arranged directly on the second housing, but only arranged at the second housing via the second cardan joint.

In a further exemplary embodiment of the optical system according to the invention, provision is additionally or alternatively made for the second image stabilizing unit to have at least one second erecting system in the form of a second prism erecting system or a second lens erecting system. In an in turn further exemplary embodiment of the optical system according to the invention, provision is additionally or alternatively made for the second image stabilizing unit to have at least one third mass-balancing element, wherein the third mass-balancing element is, for example, adjustably mounted along the second optical axis and/or perpendicular to the second optical axis. In this respect, provision is additionally or alternatively made for the second image stabilizing unit to have at least one fourth mass-balancing element, wherein the fourth mass-balancing element is, for example, adjustably mounted along the second optical axis and/or perpendicular to the second optical axis. The third mass-balancing element and/or the fourth mass-balancing element are used to set the center of gravity of the second image stabilizing unit in the second hinge point.

In one embodiment of the optical system according to the invention, provision is additionally or alternatively made for at least one second sensor unit for establishing a movement of the optical system to be arranged at the second housing. As an alternative to this, provision is made for the second sensor unit to be arranged at the second cardan joint. By way of example, the second sensor unit is embodied as a rate sensor or accelerometer. However, the invention is not restricted to the aforementioned sensors. Rather any suitable sensor can be used as second sensor unit.

In an in turn further exemplary embodiment of the optical system according to the invention, provision is made for the first housing to be connected to the second housing via at least one folding bridge. The folding bridge comprises a first hinge part arranged at the first housing and a second hinge part arranged at the second housing. The folding bridge renders it possible to set the optical system in such a way that the first housing and the second housing can be set to the pupillary distance of a user. Accordingly, the first housing and the second housing are arranged relative to one another in such a way that the first housing is arranged on one of the two eyes of the user and in such a way that the second housing is arranged on the other one of the two eyes of the user. In a further exemplary embodiment of the optical system according to the invention, provision is additionally or alternatively made for at least one third sensor unit to be arranged at the folding bridge. By way of example, the third sensor unit is used to determine the angular position (fold position) of the folding bridge. The determined angular position and a signal from the first sensor unit or the second sensor unit then render it possible to actuate at least one of the aforementioned drive units in such a way that sufficient stabilization of the image position is provided. An advantage of this embodiment is that, in addition to the third sensor unit, only one further sensor unit (i.e. either the first sensor unit or the second sensor unit) is required for actuating at least one of the aforementioned drive units in a sufficiently good manner.

In an in turn further exemplary embodiment of the optical system according to the invention, provision is additionally or alternatively made for the first housing to be embodied as a tube. In addition or as an alternative to this, provision is made for the second housing to be embodied as a tube. In an in turn further exemplary embodiment of the optical system according to the invention, the optical system is embodied as field glasses or as a telescope.

In a further embodiment of the optical system according to the invention, provision is made for the optical system to be embodied as binocular field glasses, monocular field glasses, as a spotting scope or as a telescope.

The figures will now be used to describe the invention in more detail on the basis of exemplary embodiments. Here:

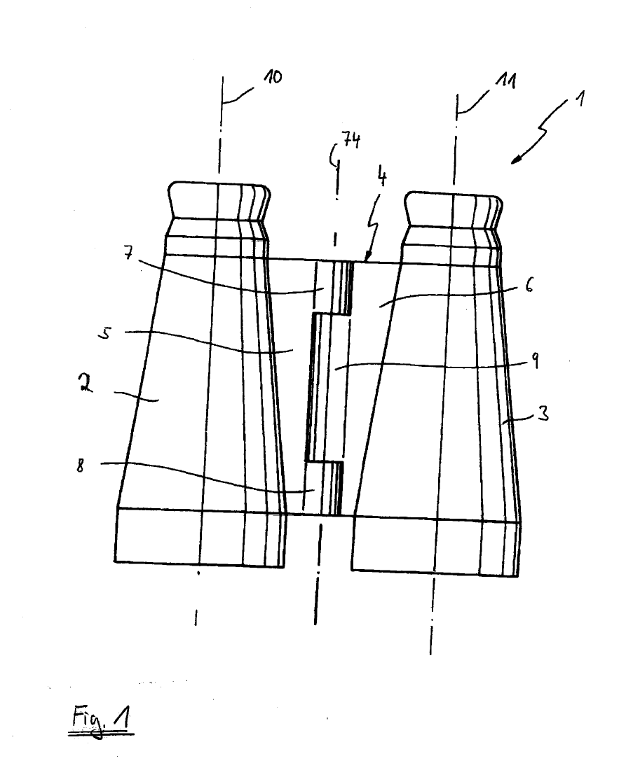

FIG. 1 shows a first schematic illustration of an optical system in the form of field glasses with a folding bridge;

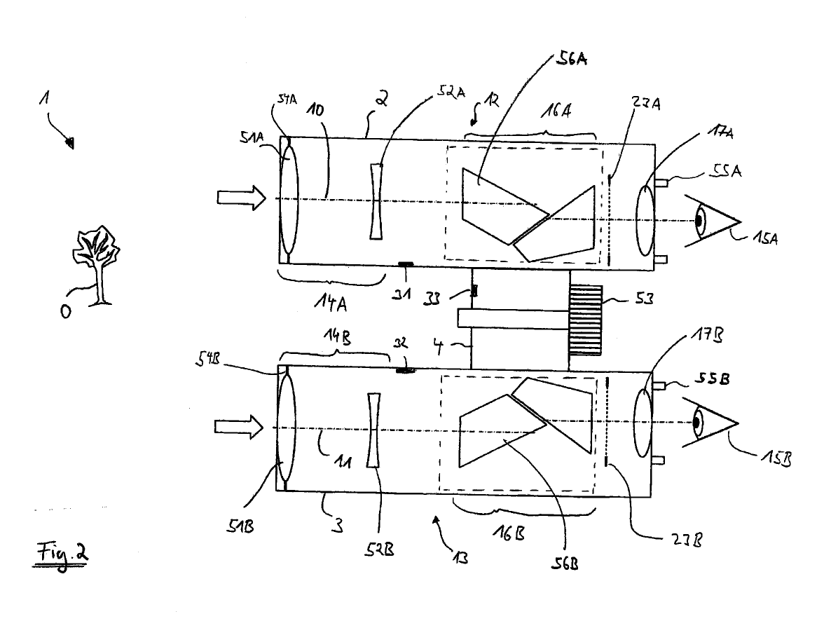

FIG. 2 shows a second schematic illustration of the field glasses according to FIG. 1;

FIG. 3 shows a third schematic illustration of the field glasses according to FIG. 1;

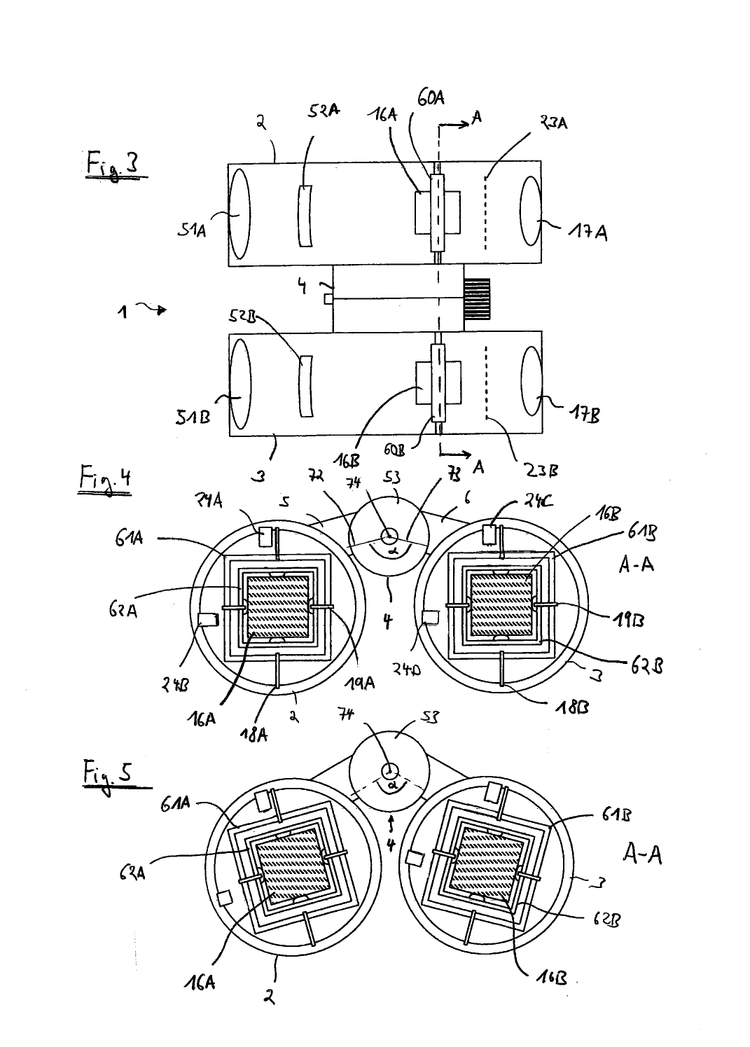

FIG. 4 shows a first sectional illustration of the field glasses along the line A-A in accordance with FIG. 3;

FIG. 5 shows a second sectional illustration of the field glasses along the line A-A in accordance with FIG. 3;

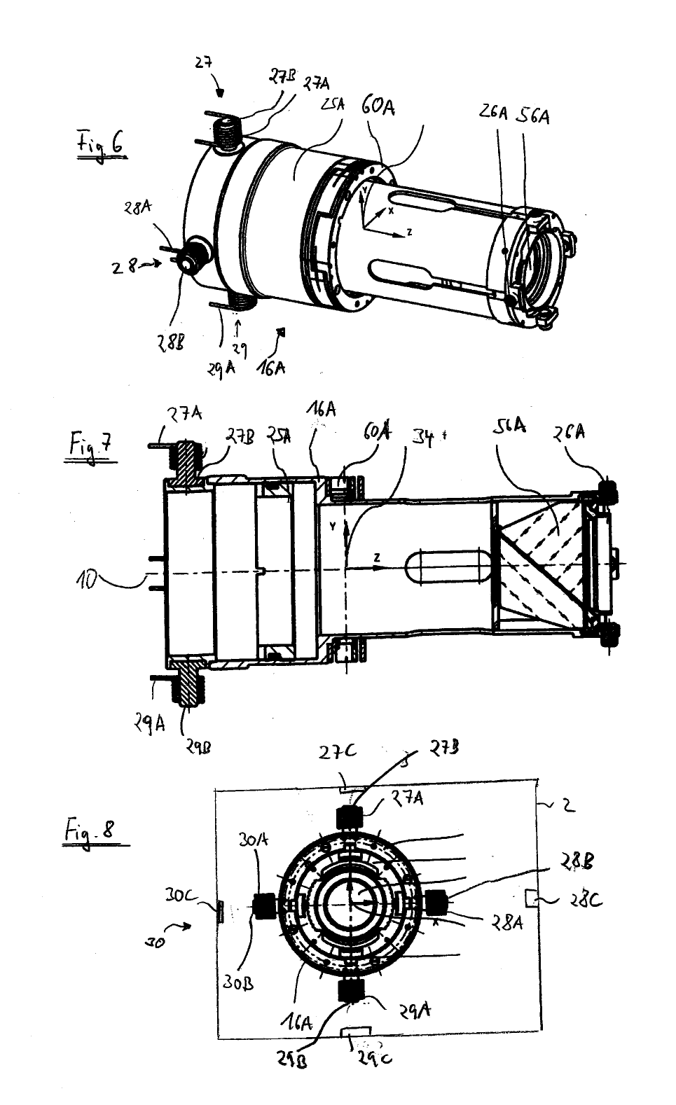

FIG. 6 shows a schematic illustration of an embodiment of an image stabilizing unit;

FIG. 7 shows a sectional illustration of the image stabilizing unit in accordance with FIG. 6;

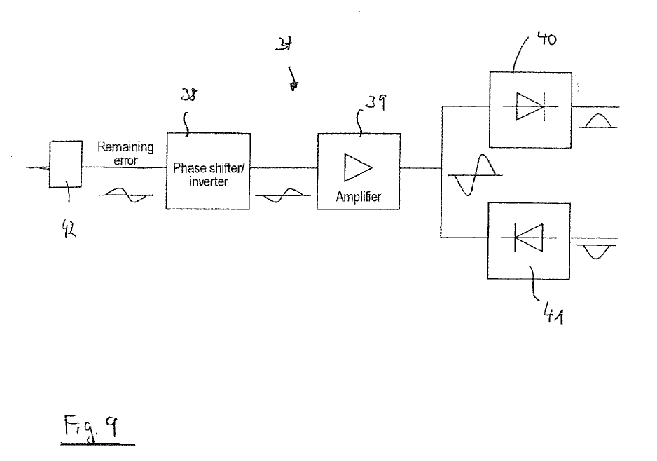

FIG. 8 shows a top view of one end of the image stabilizing unit in accordance with FIG. 6; and

FIG. 9 shows a schematic illustration of a block diagram of a control and monitoring unit for drive units of the field glasses.

In the following text, the invention will be discussed on the basis of an optical system in the form of binocular field glasses 1 (only referred to as field glasses below). However, reference is explicitly made to the fact that the invention is not restricted to binocular field glasses. Rather, the invention is suitable for any optical system, for example also in a telescope.

FIG. 1 shows a first schematic illustration of the field glasses 1, which have a tubular first housing part 2 and a tubular second housing part 3. A first optical axis 10 extends through the first housing part 2. By contrast, a second optical axis 11 extends through the second housing part 3. The first housing part 2 is connected to the second housing part 3 by means of a folding bridge 4. The folding bridge 4 has a first hinge part 5, which is formed on the first housing part 2. Furthermore, the folding bridge 4 has a second hinge part 6, which is arranged at the second housing part 3. The first hinge part 5 has a first holding part 7 and a second holding part 8, between which a third holding part 9 of the second hinge part 6 is arranged. Extending through the first holding part 7, the second holding part 8 and the third holding part 9 is an axle pin (not illustrated) such that the relative position of the first housing part 2 and the second housing part 3 can be set with respect to one another about a joint axis 74. This renders it possible to set the first housing part 2 and the second housing part 3 to the pupillary distance of a user such that, firstly, the first housing part 2 is arranged on one of the two eyes of the user and such that, secondly, the second housing part 3 is arranged on the other one of the two eyes of the user.

FIG. 2 shows a further illustration of the field glasses 1. The first housing part 2 has a first optical subsystem 12. The first optical subsystem 12 is provided with a first objective 14A, with a first image stabilizing unit 16A (illustrated in dashed manner) comprising a first prism erecting system 56A, and a first eyepiece 17A. A first eye 15A of a user can be arranged on the first eyepiece 17A for observing an object O. As a result of the first prism erecting system 56A, the first optical axis 10 of the first optical subsystem 12 is slightly offset laterally, and so there is a step-like embodiment of the first optical axis 10.

In this exemplary embodiment, the first objective 14A consists of a first front unit 51A and a first focusing unit 52A. Further embodiments of the first objective 14A provide for a different number of individual lenses or cemented elements consisting of lenses. For the purposes of focusing the object O observed through the field glasses 1, it is possible to displace either the first eyepiece 17A or the first focusing unit 52A axially along the first optical axis 10. In a further embodiment, the first front unit 51A or even the whole first objective 14A is displaced along the first optical axis 10. In a further embodiment, the first front unit 51A and the first focusing unit 52A are displaced relative to one another.

The second housing part 3 has a second optical subsystem 13. The second optical subsystem 13 is provided with a second objective 14B, with a second image stabilizing unit 16B (illustrated in dashed manner) comprising a prism erecting system 56B, and a second eyepiece 17B. A second eye 15B of the user can be arranged on the second eyepiece 17B for observing the object O. As a result of the second prism erecting system 56B, the second optical axis 11 of the second optical subsystem 13 is slightly offset laterally, and so there is a step-like embodiment of the second optical axis 11.

In this exemplary embodiment, the second objective 14B consists of a second front unit 51B and a second focusing unit 52B. Further embodiments of the second objective 14B provide for a different number of individual lenses or cemented elements consisting of lenses. For the purposes of focusing the object O observed through the field glasses 1, it is possible to displace either the second eyepiece 17B or the second focusing unit 52B axially along the second optical axis 11. In a further embodiment, the second front unit 51B or even the whole second objective 14B is displaced along the second optical axis 11. In a further embodiment, the second front unit 51B and the second focusing unit 52B are displaced relative to one another.

In both of the optical subsystems 12, 13 illustrated above, the beam direction of the light rays incident on the optical subsystems 12, 13 is as follows: object O—objective 14A, 14B—image stabilizing unit 16A, 16B—eyepiece 17A, 17B—eye 15A, 15B.

For the purposes of focusing, a control knob 53 is arranged at the folding bridge 4 in the exemplary embodiment illustrated here, by means of which control knob the first focusing unit 52A and the second focusing unit 52B can be displaced together along the two optical axes 10 and 11. In a further embodiment, provision is made for the first objective 14A and the second objective 14B (or at least units of the first objective 14A and of the second objective 14B) to be adjusted relative to one another.

In the exemplary embodiment illustrated here, both the first objective 14A and the second objective 14B generate a real image, upside down relative to the observed object O, in an image plane associated with the respective objective 14A, 14B. The first prism erecting system 56A, associated with the first objective 14A, and the second prism erecting system 56B, associated with the second objective 14B, are used for erecting the image. Hence the upside-down image is erected again and imaged in a new image plane, the left intermediate image plane 23A or the right intermediate image plane 23B. The first prism erecting system 56A and the second prism erecting system 56B can be designed as Abbe-König prism system, Schmidt-Pechan prism system, Uppendahl prism system, Porro prism system or another prism system variant.

By way of example, in the left intermediate image plane 23A, a first field stop is arranged which sharply delimits the visual field. Furthermore, for example, a second field stop which sharply delimits the visual field can be arranged in the right intermediate image plane 23B.

The first eyepiece 17A is used to image the image of the left intermediate image plane 23A at any distance, e.g.

at infinity or at a different distance. Furthermore, the second eyepiece 17B is used to image the image of the right intermediate image plane 23B at any distance, e.g. at infinity or at a different distance.

The first aperture stop 54A of the first optical subsystem 12 and the second aperture stop 54B of the second optical subsystem 13 can be formed either by a mount of an optical element of the corresponding optical subsystem 12, 13, generally by the mount of the lenses of the first front unit 51A or of the second front unit 51B, or by a separate stop. In the beam direction, it can be imaged by the corresponding optical subsystem 12 or 13 in a plane, which is situated downstream of the corresponding eyepiece 17A or 17B in the beam direction and typically has a distance of 5 to 25 mm therefrom. This plane is called the plane of the exit pupil.

In order to protect the user from laterally incident light, a first eye cup 55A, which can be pulled out, rotated out or folded out, can be provided on the first eyepiece 17A and a second eye cup 55B, which can be pulled out, rotated out or folded out, can be provided on the second eyepiece 17B.

FIG. 3 shows a further schematic illustration of the field glasses 1. FIG. 3 is based on FIG. 2. The same components are provided with the same reference signs. FIG. 3 now also shows the movement devices for the first image stabilizing unit 16A and the second image stabilizing unit 16B. The first image stabilizing unit 16A is arranged in a first cardan suspension 60A. The second image stabilizing unit 16B is arranged in a second cardan suspension 60B.

The arrangement of the two image stabilizing units 16A and 16B is illustrated in more detail in FIGS. 4 and 5. The first cardan suspension 60A has a first external suspension 61A, which is arranged at the first housing part 2 via a first axis 18A. The first external suspension 61A is rotatably arranged about the first axis 18A. Furthermore, the first cardan suspension 60A has a first internal suspension 62A, which is rotatably arranged at the first external suspension 61A via a second axis 19A.

In the embodiment illustrated in FIG. 4, the first image stabilizing unit 16A is adjusted by two individual drive devices. However, reference is explicitly made to the fact that the invention is not restricted to this number of drive devices. Rather, any suitable number of drive devices can be used in the invention, as will still be explained in the following text for a further exemplary embodiment. A first drive device 24A is used to rotate the first internal suspension 62A about the second axis 19A. Furthermore, provision is made for a second drive device 24B, by means of which the first external suspension 61A is rotated about the first axis 18A.

The second image stabilizing unit 16B is arranged at the second cardan suspension 60B. The second cardan suspension 60B has a second external suspension 61B, which is arranged at the second housing part 3 via a third axis 18B. The second external suspension 61B is rotatably arranged about the third axis 18B. Furthermore, the second cardan suspension 60B has a second internal suspension 62B which is rotatably arranged at the second external suspension 61B via a fourth axis 19B. A third drive device 24C is used to rotate the second internal suspension 62B about the fourth axis 19B. Furthermore, provision is made for a fourth drive device 24D, by means of which the second external suspension 61B is rotated about the third axis 18B. In respect of the number of drive devices, the statements made above also apply in this case.

Each of the aforementioned drive devices 24A to 24D is designed for contactless driving of the first image stabilizing unit 16A. By way of example, the aforementioned drive devices 24A to 24D are embodied as electromagnetic actuators or as capacitive actuators. The first drive device 24A and the second drive device 24B move the first image stabilizing unit 16A by tilting the first image stabilizing unit 16A about the first axis 18A and/or the second axis 19A by the provision of an adjustment force. Furthermore, the third drive device 24C and the fourth drive device 24D move the second image stabilizing unit 16B by tilting the second image stabilizing unit 16B about the third axis 18B and/or the fourth axis 19B by the provision of an adjustment force.

As already mentioned above, it is possible to set the relative position of the first housing part 2 and of the second housing part 3 in the field glasses 1 in such a way that, firstly, the first housing part 2 is arranged on one of the two eyes of the user and in such a way that, secondly, the second housing part 3 is arranged on the other one of the two eyes of the user. When the relative position is set, a so-called folding-bridge angle a between a first hinge-part axis 72 of the first hinge part 5 and a second hinge-part axis 73 of the second hinge part 6 is modified, wherein the first hinge-part axis 72 and the second hinge-part axis 73 have a common intersection with the joint axis 74.

FIGS. 6 to 8 show illustrations of a further exemplary embodiment of the first image stabilizing unit 16A, as can be arranged in the first housing part 2. The exemplary embodiment of FIGS. 6 to 8 is based on the exemplary embodiment of FIGS. 3 to 5. The same components are therefore provided with the same reference signs. Since the second image stabilizing unit 16B has an identical design to the first image stabilizing unit 16A, the explanations below also apply to the second image stabilizing unit 16B.

In the embodiment of the first image stabilizing unit 16A, illustrated in FIGS. 6 to 8, the first image stabilizing unit 16A has a tubular design. It is therefore also referred to as stabilizing tube. The first image stabilizing unit 16A has a center of gravity 34. The first image stabilizing unit 16A is furthermore arranged in the first housing part 2 by means of the first cardan suspension 60A in such a way that it is rotatably mounted about two axes arranged at right angles to one another, namely about the first axis 18A and about the second axis 19A (cf. FIG. 4). The first axis 18A and the second axis 19A intersect at a first point of intersection (hinge point) on the first optical axis 10, which corresponds to the center of gravity 34. In order to ensure that the center of gravity 34 can always lie at the first point of intersection, the first image stabilizing unit 16A has a first mass-balancing element 25A and a second mass-balancing element 26A. Both the first mass-balancing element 25A and the second mass-balancing element 26A are displaceably mounted along the first optical axis 10 and perpendicular to the optical axis 10 in such a way that the center of gravity 34 of the first image stabilizing unit 16A can always be placed at the first point of intersection of the first axis 18A and the second axis 19A.

The first image stabilizing unit 16A has a first end and a second end. Arranged at the first end of the first image stabilizing unit 16A is the first prism erecting system 56A, the function of which was already explained further above. Arranged at the second end of the first image stabilizing unit 16A are four drive units, namely a first drive unit 27, a second drive unit 28, a third drive unit 29 and a fourth drive unit 30. The first drive unit 27 has a first coil 27A, a first core element 27B and a first armature element 27C. Furthermore, the second drive unit 28 has a second coil 28A, a second core element 28B and a second armature element 28C. The third drive unit 29 in turn has a third coil 29A, a third core element 29B and a third armature element 29C. Moreover, the fourth drive unit 30 is provided with a fourth coil 30A, a fourth core element 30B and a fourth armature element 30C. Each of the aforementioned coils 27A to 30A is wound around the core element 27B to 30B associated therewith. Furthermore, each of the aforementioned coils 27A to 30A and the core element 27B to 30B correspondingly associated therewith are arranged at the first image stabilizing unit 16A at an angle of 90°. By contrast, the aforementioned armature elements 27C to 30C are arranged at an angle of 90° on the first housing part 2 (cf. FIG. 8). The aforementioned drive units 27 to 30 act in such a way that the relative position of the first image stabilizing unit 16A can be set in respect of the first housing part 2 by tilting about the first axis 18A and/or the second axis 19A (cf. FIG. 4). Here, the first drive unit 27 and the third drive unit 29 are used for tilting about the second axis 19A. By contrast, the second drive unit 28 and the fourth drive unit 30 are used for tilting about the first axis 18A. The aforementioned drive units 27 to 30 are arranged at a distance from the center of gravity 34, which lies in the first point of intersection, in order to obtain a movement of the first image stabilizing unit 16A using small adjustment forces.

In order to be able to capture movements of the field glasses 1, which are created for example on account of a tremor movement of a user, a first sensor unit 31 is arranged at the first housing 2 in all exemplary embodiments described here (cf. FIG. 2). Moreover, a second sensor unit 32 for capturing a movement of the field glasses 1 is arranged at the second housing part 3. As an alternative to this, provision is made for the first sensor unit 31 to be arranged at the first cardan suspension 60A and/or for the second sensor unit 32 to be arranged at the second cardan suspension 60B. In this exemplary embodiment, the first sensor unit 31 and the second sensor unit 32 are embodied as rate sensors or accelerometers. However, the invention is not restricted to the aforementioned sensors. Rather, any suitable sensor can be used as first sensor unit 31 and/or as second sensor unit 32.

The invention ensures that good stabilization of the image position is ensured when the field glasses 1 are moved. These movements are referred to as disturbances below, which are distinguished by a disturbance frequency and a disturbance amplitude. Interfering tremor movements by a user of the field glasses 1 generally have a disturbance frequency in the range from 0 Hz to 100 Hz. The greatest disturbance amplitudes in this case generally lie at disturbance frequencies in a range from 0.5 Hz to 2 Hz. The disturbance amplitudes decrease exponentially for higher frequencies. In general, disturbances with disturbance frequencies of greater than 20 Hz can hardly be noticed any more.

The functionality of the invention will be described in the following text. The image position is stabilized firstly by the inertia of the first image stabilizing unit 16A (or of the second image stabilizing unit 16B). It was found that the degree of stabilization of the image position is sufficiently good for disturbances with disturbance frequencies in a range from 0 Hz to 10 Hz. For disturbances with disturbance frequencies above 10 Hz, a degree of stabilization of the image position of up to 85% is obtained. In order now to obtain a higher degree of stabilization of the image position, stabilization is now obtained by means of the above-described drive devices 24A to 24D or drive units 27 to 30. This is an active regulated stabilization, which, in the exemplary embodiments described here, only still provides the portion of the stabilization of the image position for obtaining a degree of stabilization of the image position of almost 100% or precisely 100%.

In the following text, the active regulated stabilization of the image position for the first image stabilizing unit 16A is described in more detail. Corresponding statements apply to the active regulated stabilization of the image position for the second image stabilizing unit 16B.

The first sensor unit 31 has two functions. Firstly, the first sensor unit 31 serves for capturing a movement of the first housing part 2. Secondly, the first sensor unit 31 serves for capturing the relative movement of the first image stabilizing unit 16A with respect to the first housing part 2, which occurs as a result of the inertia of the first image stabilizing unit 16A. Here, the relative movement is captured both in respect of the first axis 18A and also in respect of the second axis 19A. In order to achieve a very high degree of stabilization of the image position, it is desirable for the movement of the first housing part 2 and the relative movement of the first image stabilizing unit 16A with respect to the first housing part 2 to have the same amplitude and to run in opposite phases.

Accordingly, the deflection amplitude and the phase shift of the movement of the first housing part 2 and of the relative movement of the first image stabilizing unit 16A with respect to the first housing part 2 are determined in order to determine control signals for the aforementioned drive devices 24A and 24B or drive units 27 to 30. Furthermore, a disturbance angle, which is given by the deflection amplitude of the movement of the first housing part 2, and a relative angle, which is given by the relative movement of the first image stabilizing unit 16A with respect to the first housing part 2, is determined and added. This renders it possible to determine by what remaining angle the first image stabilizing unit 16A must be tilted about the first axis 18A and/or the second axis 19A in order to obtain a degree of stabilization of the image position of almost 100% or precisely 100%. FIG. 9 shows the block diagram for a control and monitoring unit 37 of the first drive unit 27 and the third drive unit 29, which are used for tilting the first image stabilizing unit 16A about the second axis 19A. A signal which reproduces the established remaining angle is firstly phase shifted and secondly inverted by means of a phase shifter/inverter 38. The signal is subsequently amplified by means of an amplifier 39. The amplified signal is processed by means of a first operation amplifier 40 in such a way that a positive part of the signal is generated and subsequently supplied to the first drive unit 27. Furthermore, the amplified signal is processed by means of a second operation amplifier 41 in such a way that a negative part of the signal is generated and subsequently supplied to the third drive unit 29. In principle, the two aforementioned operation amplifiers 40 and 41 cut off the part of the amplified signal which should not be used for actuating the respective drive unit.

Additionally, a third sensor unit 33 is arranged at the folding bridge 4 in the exemplary embodiment illustrated here (cf. FIG. 2). The third sensor unit 33 is designed as a folding-bridge sensor and establishes the folding-bridge angle a between the first hinge-part axis 72 of the first hinge part 5 and the second hinge-part axis 73 of the second hinge part 6, wherein the first hinge-part axis 72 and the second hinge-part axis 73 have a common point of intersection with the joint axis 74 (cf. FIGS. 4 and 5). Here, provision is for example made for the third sensor unit 33 to be used to determine the actual folding-bridge angle α, which is explained in the following text. By way of example, the folding-bridge angle α in FIG. 4, in which the first axis 18A and the third axis 18B are arranged parallel to one another, can already be 175°. Now, FIG. 5 illustrates an alignment of the first hinge-part axis 72 and the second hinge-part axis 73, in which the folding-bridge angle α is e.g. 145°. Then the actual folding-bridge angle α in respect of the first axis 18A and the third axis 18B is the difference between the two measured folding-bridge angles, i.e. 30°. The folding-bridge angle established in this or a similar fashion now renders possible a transformation of coordinates of a first coordinate system of components of the first housing part 2 into coordinates of a second coordinate system of components of the second housing part 3. Using the determined folding-bridge angle a and a signal from the first sensor unit 31 or the second sensor unit 32 then renders it possible to actuate at least one of the aforementioned drive units or drive devices in such a way that a sufficient degree of stabilization of the image position is provided. An advantage of this embodiment is that that only one further sensor unit (i.e. either the first sensor unit 31 or the second sensor unit 32) is required in addition to the third sensor unit 33 for actuating at least one of the aforementioned drive units or drive devices in a sufficiently good manner.

In a further embodiment of the invention, provision is made for it to be possible to switch the active stabilization on or off, depending on the movement. By way of example, a stabilization of the image position is sometimes undesirable when observing a moving object. For this reason, the control and monitoring unit 37 has the option of being able to determine the type of the disturbance. To this end, provision is made for a processor 42. One option for the manner of the distinction lies in the disturbance frequency and the disturbance amplitude. Deliberations have shown that movements as a result of following an observed movable object generally lie below 1.5 Hz. The deflection (amplitude) is significantly greater than amplitudes of a trembling movement of a user, wherein the amplitudes of the trembling movement of a user generally are up to ±0.5°. If a moving object is being followed with the field glasses 1, the processor 42 can switch off the active stabilization.

In a further embodiment, provision is made for the processor 42 to switch off the active stabilization only in respect of an individual one of the tilt axes, i.e. the first axis 18A and the second axis 19A. The first image stabilizing unit 16A continues to be tilted in respect of the other axis.

The active stabilization described here is also very helpful for a completely different purpose. The field glasses generally have a binocular error, which is given by the deviation of the two optical axes with respect to one another. The two optical axes should be as parallel to one another as possible. Deviations from an acceptable maximum binocular error are, for example, captured in the processor 42. During operation, the active stabilization now renders it possible to reduce the binocular error by means of a suitable actuation of the active stabilization in such a way that the acceptable maximum binocular error is undershot.

In a further embodiment of the invention, provision is made for the active stabilization described here to be combined with passive image stabilization with viscous damping (for example using an eddy current brake).

### LIST OF REFERENCE SIGNS

1 Field glasses
2 First housing part
3 Second housing part
4 Folding bridge
5 First hinge part
6 Second hinge part
7 First holding part
8 Second holding part
9 Third holding part
10 First optical axis
11 Second optical axis
12 First optical subsystem
13 Second optical subsystem
14A First objective
14B Second objective
15A First eye
15B Second eye
16A First image stabilizing unit
16B Second image stabilizing unit
17A First eyepiece
17B Second eyepiece
18A First axis
18B Third axis
19A Second axis
19B Fourth axis
23A Left intermediate image plane
23B Right intermediate image plane
24A First drive device
24B Second drive device
24C Third drive device
24D Fourth drive device
25A First mass-balancing element
26A Second mass-balancing element
27 First drive unit
27A First coil
27B First core element
27C First armature element
28 Second drive unit
28A Second coil
28B Second core element
28C Second armature element
29 Third drive unit
29A Third coil
29B Third core element
29C Third armature element
30 Fourth drive unit
30A Fourth coil
30B Fourth core element
30C Fourth armature element
31 First sensor unit
32 Second sensor unit
33 Third sensor unit
34 First point of intersection (center of gravity)
37 Control and monitoring unit
38 Phase shifter/inverter
39 Amplifier
40 First operation amplifier
41 Second operation amplifier
42 Processor
51A First front unit
51B Second front unit
52A First focusing unit
52B Second focusing unit
53 Control knob
54A First aperture stop
54B Second aperture stop
55A First eye cup
55B Second eye cup
56A First prism erecting system
56B Second prism erecting system
60A First cardan suspension
60B Second cardan suspension
61A First external suspension
61B Second external suspension
62A First internal suspension
62B Second internal suspension
72 First hinge-part axis
73 Second hinge-part axis
74 Joint axis
O Object

1-17. (canceled)

18. An optical system for imaging an object, comprising:
at least one first objective;
at least one first image stabilizing unit;
at least one first eyepiece; and
at least one first drive unit for contactless driving of the first image stabilizing unit,
wherein, as seen from the first objective in the direction of the first eyepiece, the first objective is arranged first along a first optical axis in a first housing, followed by the first image stabilizing unit and then the first eyepiece,
wherein the first image stabilizing unit is mounted in a cardan-joint fashion in the first housing, rotatably about a first hinge point, and
wherein the first hinge point is arranged between the first objective and the first eyepiece.

19. The optical system according to claim 18, wherein the first drive unit includes an electromagnetic actuator or a capacitive actuator.

20. The optical system according to claim 18, further comprising at least one of the following features:
(i) at least one second drive unit for contactless driving of the first image stabilizing unit,
(ii) at least one third drive unit for contactless driving of the first image stabilizing unit, or
(iii) at least one fourth drive unit for contactless driving of the first image stabilizing unit.

21. The optical system according to claim 20, wherein at least one of the following features is provided:
(i) the second drive unit includes an electromagnetic actuator or a capacitive actuator,
(ii) the third drive unit includes an electromagnetic actuator or a capacitive actuator, or
(iii) the fourth drive unit includes an electromagnetic actuator or a capacitive actuator.

22. The optical system according to one of claim 20, wherein at least one of the drive units from the set containing the first drive unit, the second drive unit, the third drive unit and the fourth drive unit includes at least one first drive element and at least one second drive element, wherein the first drive element is arranged at the first housing, and wherein the second drive element is arranged at the first image stabilizing unit.

23. The optical system according to claim 18, wherein at least one of the following features is provided:
(i) the first image stabilizing unit has a tubular design,
(ii) the first image stabilizing unit has at least one first erecting system in the form of a first prism erecting system or a first lens erecting system,
(iii) the first image stabilizing unit has at least one first mass-balancing element, wherein the first mass-balancing element is adjustably mounted according to at least one of: along the first optical axis or perpendicular to the first optical axis, or
(iv) the first image stabilizing unit has at least one second mass-balancing element, wherein the second mass-balancing element is adjustably mounted according to at least one of: along the first optical axis or perpendicular to the first optical axis.

24. The optical system according to claim 18, further comprising:
at least one first sensor unit for establishing a movement of the optical system, the at least one first sensor unit being arranged at the first housing.

25. The optical system according to claim 18, further comprising at least one of the following:
at least one second objective,
at least one second image stabilizing unit, and
at least one second eyepiece,
wherein, as seen from the second objective in the direction of the second eyepiece, the second objective is arranged first along a second optical axis in a second housing, followed by the second image stabilizing unit and then the second eyepiece,
wherein the second image stabilizing unit is mounted in a cardan-joint fashion in the second housing, rotatably about a second hinge point,
wherein the second hinge point is arranged between the second objective and the second eyepiece, and
wherein the optical system includes at least one fifth drive unit for contactless driving of the second image stabilizing unit.

26. The optical system according to claim 25, further comprising at least one of the following:
(i) at least one sixth drive unit for contactless driving of the second image stabilizing unit,
(ii) at least one seventh drive unit for contactless driving of the second image stabilizing unit, or
(iii) at least one eighth drive unit for contactless driving of the second image stabilizing unit.

27. The optical system according to claim 25, wherein the fifth drive unit includes an electromagnetic actuator or a capacitive actuator.

28. The optical system according to claim 26, wherein at least one of the following is provided:
(i) the sixth drive unit is embodied as an electromagnetic actuator or as a capacitive actuator,
(ii) the seventh drive unit is embodied as an electromagnetic actuator or as a capacitive actuator, or
(iii) the eighth drive unit is embodied as an electromagnetic actuator or as a capacitive actuator.

28. The optical system according to one of claim 26, wherein at least one of the drive units from the set containing the fifth drive unit, the sixth drive unit, the seventh drive unit and the eighth drive unit includes at least one third drive element and at least one fourth drive element, wherein the third drive element is arranged at the second housing, and wherein the fourth drive element is arranged at the second image stabilizing unit.

29. The optical system according to one of claim 25, wherein at least one of the following is provided:
(i) the second image stabilizing unit has a tubular design,
(ii) the second image stabilizing unit has at least one second erecting system in the form of a second prism erecting system or a second lens erecting system,
(iii) the second image stabilizing unit has at least one third mass-balancing element, wherein the third mass-balancing element is adjustably mounted according to at least one of: along the second optical axis or perpendicular to the second optical axis, or
(iv) the second image stabilizing unit has at least one fourth mass-balancing element, wherein the fourth mass-balancing element is adjustably mounted according to at least one of: along the second optical axis or perpendicular to the second optical axis.

30. The optical system according to claim 25, further comprising:
at least one second sensor unit for establishing a movement of the optical system is arranged at the second housing.

31. The optical system according to claim 25, wherein the first housing is connected to the second housing via at least one folding bridge, wherein the folding bridge includes a first hinge part arranged at the first housing, and wherein the folding bridge includes a second hinge part arranged at the second housing.

32. The optical system according to claim 18, characterized in that the optical system is embodied as monocular field glasses.

33. The optical system, according to claim 18, wherein the optical system is embodied as binocular field glasses, as a spotting scope or as a telescope.
